(19) United States
(12) Patent Application Publication
(10) Pub. No.: US 2022/0194047 A1
(43) Pub. Date: Jun. 23, 2022

(54) METHODS OF MAKING ROOF LAMINATES WITH REMOVABLE PROTECTIVE SHEETS AND ROOF LAMINATES

(71) Applicant: Carlisle Intangible, LLC, Scottsdale, AZ (US)

(72) Inventors: Xuan Zhang, Carlisle, PA (US); Brittany Walls, Chambersburg, PA (US); Brock Walker, St. Louis, MO (US); Anil Shenoy, Mechanicsburg, PA (US); David French, Carlisle, PA (US)

(21) Appl. No.: 17/606,478

(22) PCT Filed: Apr. 22, 2020
(86) PCT No.: PCT/US2020/029261

§ 371 Date: Oct. 26, 2021

Related U.S. Application Data
(60) Provisional application No. 62/839,053, filed on Apr. 26, 2019.

(51) Int. Cl. B32B 3/30; B32B 27/08; B32B 37/10; B32B 37/18; B32B 38/00; B32B 7/06; E04D 5/12

(52) U.S. Cl. CPC B32B 3/30; B32B 27/08; B32B 37/10; B32B 37/182; B32B 38/0008; B32B 2310/14; B32B 7/06; E04D 5/12; B32B 2307/402; B32B 2307/748; B32B 2419/06; B32B 38/0036

(57) ABSTRACT

A roof laminate (10) includes a roof membrane (12, 100, 200, 300) and a protective sheet (14, 114, 214, 314) removably affixed thereto. The surface (20) of the roof membrane (12, 100, 200, 300) can be protected from dirt, scratches and scrapes by a protective sheet (14, 114, 214, 314) which also provides other beneficial attributes that aid an installer. The membrane (12, 100, 200) and the sheet (14, 114, 214) are heat laminated together in the absence of adhesive and tackifiers. Alternatively, the membrane (12, 300) and the sheet (14, 314) are surface treated and then brought into contact with one another in the absence of adhesive and tackifiers. The sheet (14, 114, 214, 314)) may be single layer or include at least a first layer (30) directly secured to a second layer (32). The first layer (30) provides at least one of UV protection, anti-slip, and anti-glare to the roof laminate (10) and so aids the installer in at least one of those respects. The second layer (32) is removably affixed to the roof membrane (12, 100, 200, 300).

### CROSS-REFERENCE TO RELATED APPLICATIONS

This application claims priority to U.S. Application No. 62/839,053 filed on Apr. 26, 2019, and which is incorporated by reference herein in its entirety and is related to U.S. Pat. No. 8,833,037, filed Apr. 5, 2012, to U.S. Pat. No. 9,163,410 filed Jul. 20, 2014, and to U.S. application Ser. No. 15/973,955 filed on May 8, 2018, each of which is incorporated by reference herein in its entirety.

### BACKGROUND

Membrane roofs are roofs that are covered with a polymeric sheet or membrane. These polymeric membranes can be, for example, polyvinyl chloride (PVC), thermoplastic olefin (TPO), or ethylene propylene diene monomer rubber (EPDM), as well as other materials. The polymeric membrane is positioned over a roof surface and held in place by fasteners, adhesive, or ballast. Adjacent membranes are bonded together along lap seams to form a unitary single sheet of the polymer covering the entire roof.

Generally, roof membranes are either white or black. Theoretically, the membranes could be basically any color. The choice of color may be for aesthetic purposes or to reduce energy costs by reflecting thermal energy. Regardless of color, the appearance following installation is of paramount importance both from an aesthetic standpoint and from a functional standpoint.

When replacing an existing roof, new sheeting is difficult to keep clean. In a re-roofing application, a section of the old roof covering is removed and new roof membrane is immediately installed in its place. This allows the roof to be fully covered each night. As subsequent sections of the old roof are removed, the roofers walk on the newly installed membrane. This can scratch and mar the new membrane.

While these membranes have generally been commercially successful, there remains a need for additional improvements to facilitate their installation and performance.

### SUMMARY

Embodiments of the present invention are premised on the realization that during installation of a single-ply roofing membrane, the surface of the membrane can be protected from dirt, scratches and scrapes by a protective sheet which also provides other beneficial attributes that aid an installer. As an advantage, the protective sheet is adhered to the single-ply roofing membrane without adhesive.

To those and other ends, a roof laminate to be secured to a roof deck includes a roof membrane that has a first surface and a second surface and is configured to be secured to the roof deck. A protective sheet is removably affixed to the first surface in the absence of an adhesive and in the absence of a tackifier or other applied chemicals includes at least one layer directly secured to the roof membrane. The protective sheet is removably affixed to the roof membrane and is separable from the roof membrane when a force having a peel value in the range of 0.050 pound per inch to 20 pounds per inch (0.089 kilogram to 3.5 kilograms per linear centimeter) is applied to the protective sheet.

In one embodiment, a first layer is directly secured to a second layer, and the second layer is removably affixed to the roof membrane. One or both the first layer and the second layer aid the installer during installation.

In one embodiment, the protective sheet is removably affixed to the roof membrane and is separable from the roof membrane when a force having a peel value of at least 0.01 pounds per inch (0.002 kilogram per centimeter) is applied to the protective sheet.

According to one aspect, there is a method of manufacturing a roof laminate. The method includes heating one or both of a membrane and a protective sheet. While hot, the method further includes pressing the membrane and the protective sheet together in the absence of adhesive and in the absence of a tackifier or other applied chemicals between the membrane and the protective sheet. The pressure and heat being high enough to removably secure the protective sheet to the membrane but permits its removal following installation.

In one embodiment, pressing the membrane and the protective sheet together includes applying a pressure in the range of 30 to 300 pounds per linear inch (5.4 to 53.5 kilograms per linear centimeter) to the membrane and the protective sheet.

In one embodiment, pressing the membrane and the protective sheet together includes applying a pressure in the range of 30 to 100 pounds per linear inch (5.4 to 17.9 kilograms per linear centimeter) to the membrane and the protective sheet.

In one embodiment, pressing the membrane and the protective sheet together includes applying a pressure to the membrane and the protective sheet for 0.001 second to 2 seconds.

In one embodiment, heating includes heating at least one of the membrane and the protective sheet to a temperature between 100° F. (37.8° C.) and 400° F. (204° C.) while applying pressure in any one of the above mentioned ranges.

According to one aspect, there is a method of manufacturing a roof laminate. The method includes surface treating one or both of a membrane and a protective sheet. After treatment, the method further includes pressing the membrane and the protective sheet together in the absence of adhesive and in the absence of a tackifier or other applied chemicals between the membrane and the protective sheet.

In one embodiment, pressing the membrane and the protective sheet together includes applying a pressure in the range of 1 to 200 pounds per linear inch (0.2 to 36 kilogram per linear centimeter) to the membrane and the protective sheet.

In one embodiment, surface treating includes at least one of plasma treatment, coronal discharge, and flame treatment.

The objects and advantages of embodiments of the present invention will be further appreciated in light of the following detailed description and drawings in which:

### BRIEF DESCRIPTION OF THE DRAWINGS

FIG. 1 is a perspective view of one embodiment of the present invention;

FIG. 2 is a cross-sectional view of FIG. 1;

FIGS. 3 and 4 are cross-sectional views similar to FIG. 2 depicting embodiments of the invention;

FIG. 5 is a perspective view of one embodiment of the present invention during installation;

FIG. 6 is a cross-sectional view of an edge portion of the embodiment shown in FIG. 5 prior to removal of a protective sheet;

FIG. 7 is a perspective view of one embodiment of the present invention;

FIG. 8 is a cross-sectional view of one embodiment of the invention;

FIG. 9 is a cross-sectional view of one embodiment of the present invention;

FIG. 10 is a perspective view of one embodiment of the present invention;

FIG. 11 is a schematic diagram of one embodiment of the present invention;

FIG. 12 is a schematic diagram of one embodiment of the present invention;

FIGS. 13A, 13B, 13C, and 13D are schematic diagrams of interface models and molecular models;

FIG. 14 is a schematic diagram of one embodiment of the present invention.

FIG. 15 is a graph illustrating data from peel testing.

FIG. 16 is a graph illustrating average peel value as a function of temperature.

### DETAILED DESCRIPTION

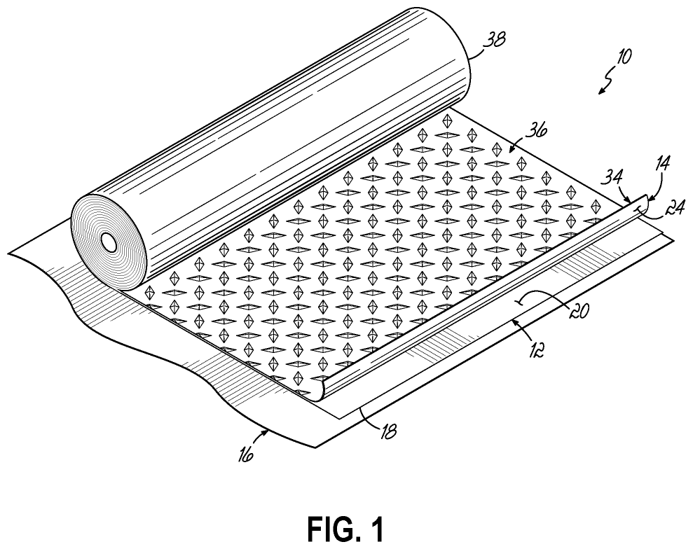

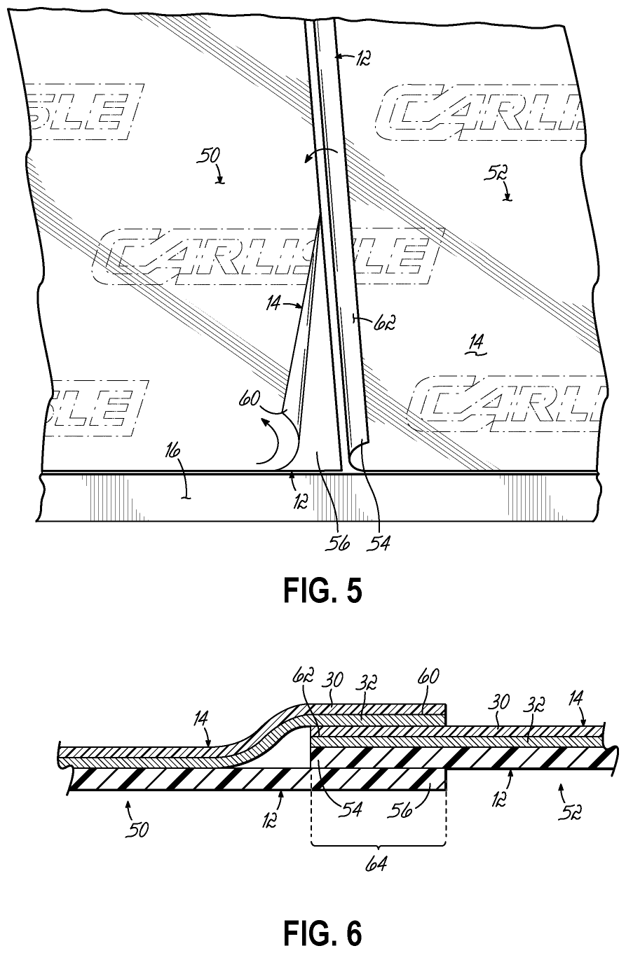

To these and other ends and with reference to FIG. 1, a roof laminate 10 includes a single ply roof membrane 12 and a release sheet or protective sheet 14. The roof laminate 10 is to be installed onto a roof, such as a roof deck 16. In that regard, multiple roof laminates 10 may be positioned in an overlapping relationship (shown in FIGS. 5 and 6 and described below) during installation of a new roof on the roof deck 16. The roof membrane 12 includes a first surface 18 and a second surface 20. The first surface 18 faces the roof deck 16 and may contact it during installation, and the second surface 20 is intended to be exposed to weather following installation and so faces in a direction away from the roof deck 16. The roof laminate 10 may be installed on the roof deck 16 with mechanical fasteners (not shown), with an adhesive (not shown)(applied during installation or factory applied) between the membrane 12 and roof deck 16, or by other means.

The protective sheet 14 includes a first surface 22 and a second surface 24, which rests on and covers the second surface 20 of roof membrane 12. The protective sheet 14 may be affixed directly to the roof membrane 12. The protective sheet 14 is in continuous and direct contact with the roof membrane 12. That is, no materials are placed between the protective sheet 14 and the roof membrane 12. The protective sheet 14 is intended to be removed following installation of a new roof and thus temporarily protects the second surface 20 of the roof membrane 12 during installation of the roof laminate 10 on the deck 16. For example, the protective sheet 14 may prevent damage to the roof membrane 12 due to roofing installers walking on the protective sheet 14 and not on the membrane 12. Removing the protective sheet 14 exposes the second surface 20 of the roof membrane 12. The protective sheet 14 is formed with multiple layers, each layer providing at least one beneficial characteristic designed to aid an installer and is described in detail below.

The roof membrane 12 can be formed from a polymer. By way of example only, the roof membrane 12 may be made of polyvinyl chloride (PVC), thermoplastic olefin (TPO), ethylene propylene diene monomer (EPDM), rubbers, polyethylene (PE), (PET), polypropylene (PP), as well as other polyolefins. While these are specific exemplary materials for the roof membrane 12, it will be appreciated that there are other materials not specifically identified that may find utility as the roof membrane 12. The roof membrane 12 can have a bottom fibrous surface referred to as fleeceback, which improves bond strength in a fully adhered system, which is with an adhesive applied between the fleeceback and the roof deck 16. The roof membrane 12 is preferably white or slightly off-white, though it can be any color. Embodiments of the present invention are most useful when the membrane 12 is a lighter color, such as white or off-white.

The roof membrane 12 is generally rectangular and can be manufactured to a variety of sizes. By way of example only, the roof membrane 12 can be as narrow as 5 feet (about 1.5 meters) to as wide as 40 feet (12 meters). Length can be from 50 feet (15 meters) to 100 feet (30.5 meters) or more. The roof membrane 12 has a thickness effective for use as a roof cover, for example, from 20 mils to 160 mils (0.5 mm to 4.2 mm) thick, and by way of additional example from 40 mils to 160 mils (1 mm to 4.2 mm) thick. The roof membrane 12 is water insoluble and designed to withstand natural environmental conditions for prolonged periods of time, for example at least 15 years.

The multiple layers of the protective sheet 14 are polymeric sheets that can be formed from a variety of different polymers. One or all of the layers may be formed from a non-environmentally degradable polymer. These materials may include any one of the materials listed above for the roof membrane 12 and also include polyethylene (including low density polyethylene (LDPE), linear low density polyethylene (LLDPE), and high density polyethylene (HDPE)), polypropylene (PP), polyamide (i.e., nylon), polyester, polyacrylate, polymethacrylate, polyvinylchloride (PVC), polyvinylidene chloride (PVDC), and combinations thereof.

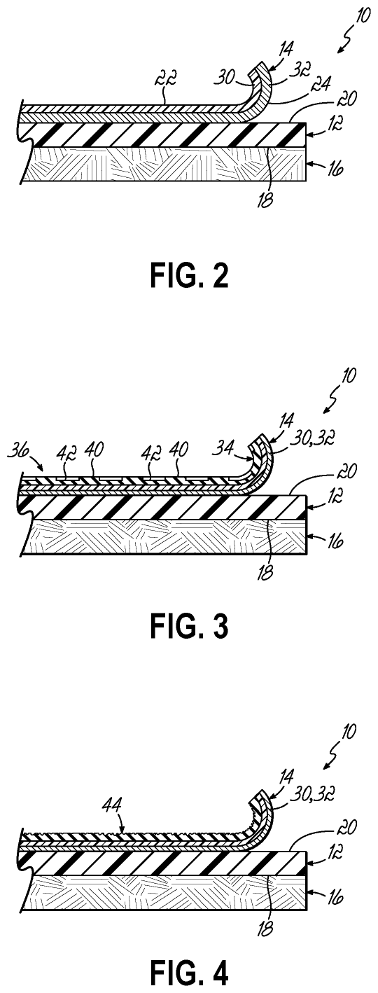

While the protective sheet 14 may be a single layer, such as that shown and described in U.S. Pat. No. 8,833,037, in one embodiment, and with reference to FIG. 2, the protective sheet 14 may include layers 30, 32, which may appear as separate films or coatings that are stacked upon one another. For example, in FIG. 2, the protective sheet 14 consists of two layers 30, 32 that are bonded together. Each layer 30, 32 may provide the laminate 10 with a different characteristic designed to aid the installer. Although not shown, layer 32 may be stacked on layer 30 and so form the surface 22 of the protective sheet 14. That is, the order of the layers 30, 32 may be altered depending on the desired attribute of the surface 22. Once the installation is complete, the layers 30, 32 are removed. This may be achieved by removing both in a single operation that removes layers 30 and 32. Alternatively, removal of layer 30 may be achieved before removal of layer 32 from the membrane 12.

In one embodiment, the layer 30 may provide color to the protective sheet 14. Although the protective sheet 14 can be clear, it is preferable that it be tinted with a color that is distinguishable from the color of the roof membrane 12. For example, if the roof membrane 12 is white, the protective sheet 14 is preferably any color other than clear or white, such as green, red, blue or yellow. A pigment or dye may be added to the layer 30 and/or 32 during its manufacture to provide the color for the protective sheet 14. In addition, and with reference to FIG. 6, by way of example, the color may vary across the width of the layer 30. For example, the layer 30 may include at least two different colors. The color in the layer 30 may be utilized to produce text or other indicia or information in the protective sheet 14. As shown, the protective sheet 14 may include advertising information but may also include instructions, warranty information, and other text/symbols.

With continued reference to FIG. 2, the other layer 32 of the layers 30 and 32 may provide UV protection for the protective sheet 14, and for the roof laminate 10 prior to removal of the protective sheet 14. This may be achieved for a short-term weather resistance, for example, a duration of 1 day to 2 years or until the sheet 14 is removed after installation. UV protection may be obtained by the addition of one or more antioxidants, UV absorber and light stabilizer additives, and light effective pigments to the layer 32. By way of example only, antioxidants may include hindered phenols, thiosynergists, hydroxylamines, phosphates, and alpha-tocopherol. Commercially available antioxidants include Irganox® and Irgafos® from BASF; Anox®, Lowinox® and Weston® from Addivant; Songnox® from Songwon; Evernox® and Everfos® from Everspring; BNX® from Mayzo; Thanox® from Rianlon. In addition, or as an alternative, UV protection may be achieved by addition of UV absorbers and light stabilizers, which may include, for example, benzotriazole, hydroxybenzoate, benzophenone, triazine, and hindered amines of various molecular weights. These additives are commercially available from BASF under the brand names Tinuvin® and Chimassorb® and from Solvay under the brand name Cyasorb®, from Sabo under the brand name SaboSTAB®, from Songwon under the brand name of Songsorb®, from Mayzo under the brand name of BLS®, from Everspring under the brand name of EverSTAB®, from Rianlon under the brand of Thasorb®, and from Addivant under the brand of Lowilite. In addition, light reflective pigments can be used to screen UV light, which may include, for example, titanium dioxide. These pigments are commercially available as Ti-Pure® from Chemours, as Kronos® TiO2 from Kronos, as Tiona® from Cristal, as Troxide® from Huntsman, and as Tronox® TiO2 from Tronox.

In one embodiment and with reference to FIG. 3, the protective sheet 14 may include one or both of the layers 30, 32 described above in FIG. 2. The protective sheet 14 may further include anti-slip layer 34 that is intended to be exposed during installation of the laminate 10 on the roof deck 16. The anti-slip layer 34 is designed to improve traction, particularly with foot traffic. By way of example only, a static, dry coefficient of friction may be greater than 0.45 and a static wet coefficient of friction may be greater than 0.6. The coefficient of friction measurements may be completed according to the ASTM D1894-14 Standard Test Method for Static and Kinetic Coefficients Of Friction Of Plastic Film and Sheeting.

With reference to FIGS. 1 and 3, the anti-slip layer 34 may be formed in a pattern 36 in or on the protective sheet 14, such as a diamond tread illustrated in FIG. 1. In FIG. 3, the pattern 36 may include raised areas 40 separated by recessed areas 42. This localized relative thickness difference in the anti-slip layer 34 produces a physical texturing on the surface 22 of the protective sheet 14. In addition, or as an alternative, the anti-slip layer 34 may include or be formed entirely by rubbery or tacky polymers, such as block copolymers (e.g., SIS and SBS), amorphous poly-alpha olefin, vinyl acetate/ethylene (VAE) and ethylene-vinyl acetate (EVA). These materials may be formed in a uniform coating on the layer 30 or 32 as the anti-slip layer 34 or they may be formed in discontinuous patterns, such as the raised and depressed areas 40, 42 in the pattern 36 on the layer 30.

With reference to FIG. 4, in one embodiment of the invention, the protective sheet 14 may include one or both of the layers 30 and 32 described above with regard to FIG. 2 with an anti-glare layer 44 forming the surface 22. However, rather than a three-layer protective sheet 14, as shown, the protective sheet 14 may include one of layers 30, 32 and the anti-glare layer 44. The anti-glare layer 44 is designed to reduce reflection of light at any angle of observation that initially impinges on the surface 22. In this way, the installation crew is not exposed to light reflection from the protective sheet 14. The anti-glare layer 44 may be achieved by increasing surface roughness of the layer 30 to a range of from 5 μm to 200 μm.

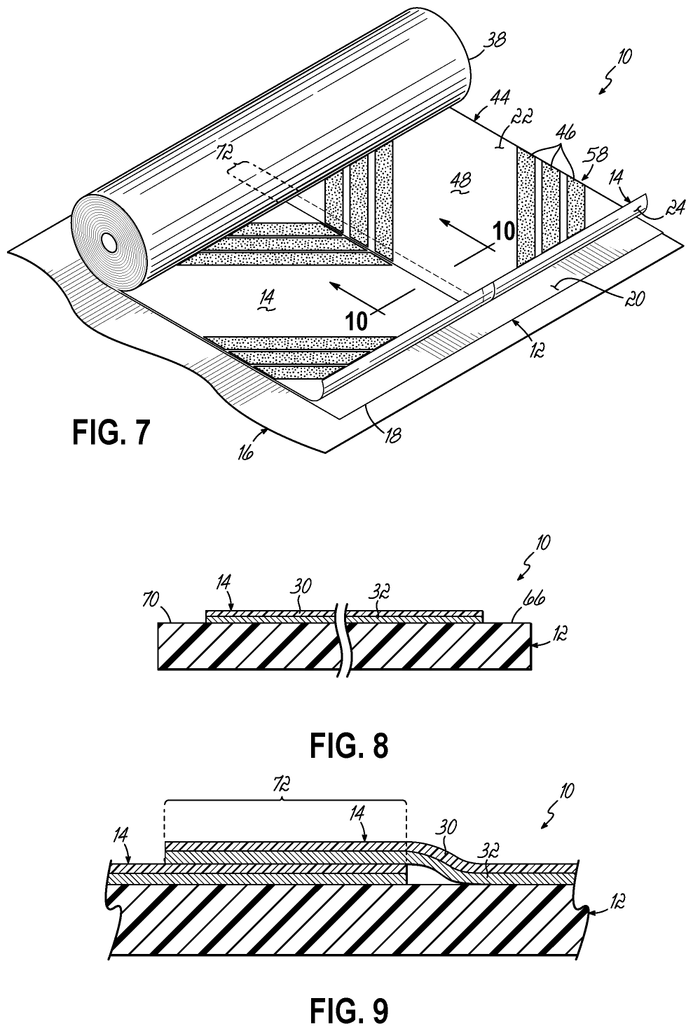

Alternatively, the anti-glare layer 44 may be produced by a separate coating (not shown) on the layer 30, which may be formed by low crystallinity polymers, such as amorphous poly-alpha olefin, vinyl acetate/ethylene (VAE) and ethylene-vinyl acetate (EVA), acrylic, or silicone. As shown in FIG. 7, the anti-glare layer 44 may include anti-glare regions 46 separated by regions 48 in a pattern 58 on the surface 22. The anti-glare layer 44 may have an intermediate gloss of less than 20 gloss units (GU) when measured at 60° in accordance with the ASTM D2457-13 Standard Test Method for Specular Gloss of Plastic Films and Solid Plastics. In one embodiment, the layer 34 or layer 44 may have both anti-slip and anti-glare characteristics in the above-identified ranges.

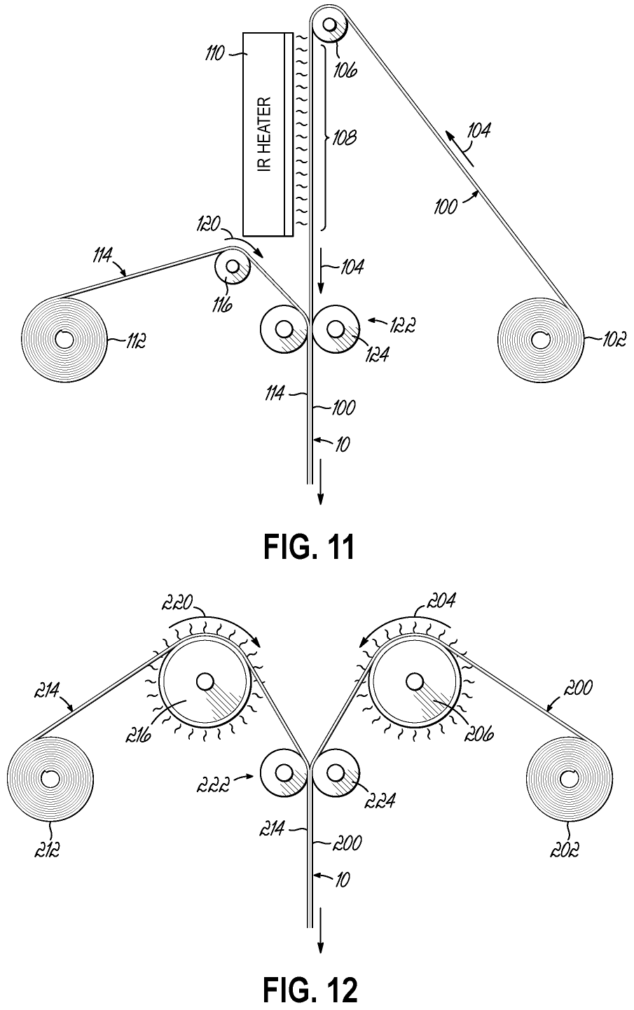

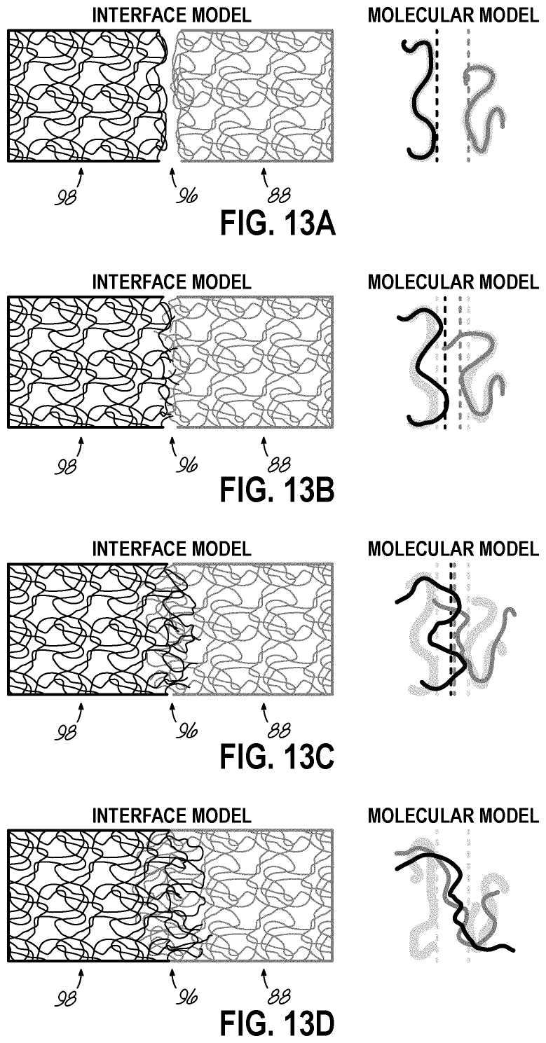

With reference to FIGS. 2-4, the protective sheet including one or more of the layers 30, 32, 34, and 44 may be made by co-extrusion, co-blowing, or a heat-lamination process, described below with reference to FIGS. 11 and 12. Advantageously, the laminate 10 may be produced without an adhesive between the roof membrane 12 and the protective sheet 14. The laminate 10 may therefore be adhesive free. When installed and the protective sheet 14 is removed, no residual materials adhere to the roof membrane 12. Dirt and other debris are less likely to stick to the exposed surface of the membrane 12 in the absence of residual adhesive. Moreover, the laminate 10 is of substantially less weight making it less strenuous to install.

To apply the roof membrane 12 over the roof deck 16 and with reference to FIGS. 5 and 6, two adjacent roof laminates 50 and 52 are laid down side by side over the roof deck 16. The roof membrane 12 of first laminate 50 is fixed to the roof deck 16, generally using adhesives (not shown) or fasteners (not shown). The second roof laminate 52 is rolled out and adhered to the roof deck 16 adjacent the first laminate 50 with an edge 54 of the second laminate 52 overlapping an edge 56 of the first laminate 50. The overlapping edges 54 and 56 are adhered or welded to each other.

With the embodiment shown in FIGS. 5 and 6, an edge portion 60 of the protective sheet 14 on the first roof laminate 50 is pulled up enough to allow an edge 62 of the second protective sheet 14 to overlap the exposed edge 56 of the first laminate 50. The overlapping edges 54 and 56 are then bonded together by heat or adhesive. As shown in FIG. 6, the edge portion 60 of the protective sheet 14 from the first roof laminate 50 is then folded back and rests over an overlapped portion 64 of the two membranes 12.

As shown in FIG. 1, the protective sheet 14 covers the entire roof membrane 12 from edge to edge. However, as shown in FIG. 8, the protective sheet 14 may cover the entire membrane except for 4- to 12-inch (10 to 31 centimeters) portions on either edges 66 and 70 of the roof laminate 10. Alternatively, as shown in FIGS. 1 and 9, the protective sheet 14 can include an overlap region 72 at which two separate protective sheets 14 may be bonded together.

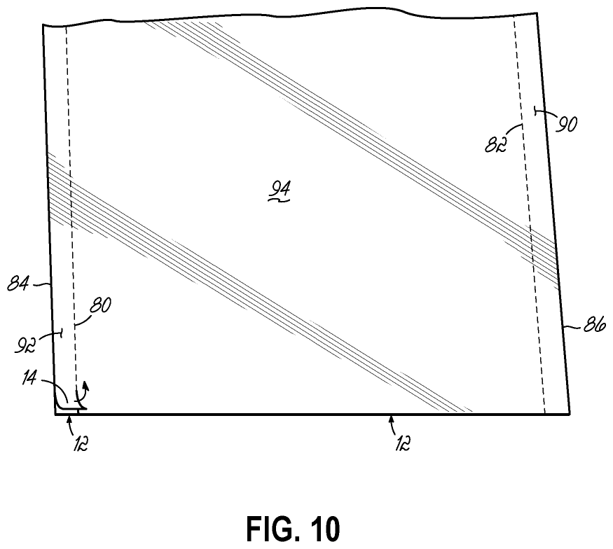

In FIG. 10, perforations 80, 82 may be formed alongside edges 84 and 86. The perforations 80, 82 allow strips 90 and 92 to be removed from the protective sheet 14 leaving the field portion 94 of the protective sheet 14 protecting the membrane 12. These embodiments allow the adjacent membranes 12 to be bonded together while the field portion 94, shown in FIG. 10, remains on the membrane 12.

Once the roof is fully installed, all of the protective sheets 14 are pulled away from the membrane 12 leaving an exposed white or colored membrane surface free of scratches and dirt.

In one embodiment and with reference to FIG. 11, the roof laminate 10 is formed by heating a membrane 100, which may be supplied via a stock roll 102. As shown, the membrane 100 is pulled from the roll 102 according to arrow 104 around roller 106 and proximate heater 110. The heater 110 may be an IR heater capable of heating the membrane 100 to a temperature of between 100° F. (37.8° C.) and 400° F. (204° C.). The temperature of the membrane 100 may be dependent on the material of the membrane 100 as well as other process conditions described below. By way of further example only, the heater 110 may heat the membrane 100 so that upon exiting a heat zone 108, the membrane 100 has a temperature of about 240° F. (about 116° C.) (i.e., within a few degrees of 240° F. (116° C.), e.g., plus or minus 3° F. (plus or minus 1.7° C.)). The heater 110 heats the membrane 100 prior to forming the roof laminate 10.

At the same time, a roll 112 is unwound and a sheet 114 from the roll 112 passes around roller 116 according to arrow 120. Although not shown in FIG. 11, the sheet 114 may be a multilayer protective sheet 14 shown, for example, in FIGS. 2-4 or a single layer sheet. Multilayer sheets may be preassembled prior to being assembled with the membrane 100 as shown in FIG. 11. In that regard, each of the sheet 114 and the membrane 100 contact one another at 122. That is, at 122 the sheet 114 is stacked against the membrane 100. No adhesive, tackifiers, or chemicals are applied to or between the sheet 114 and the membrane 100. The sheet 114 is not intentionally stretched prior to or during contact with the membrane 100 at 122. As an example, each of membrane 100 and the sheet 114 contact one another at 122 and pass through a nip roller 124 and so are pressed together to form the laminate 10. The nip roller 122 may apply pressure in a range from 30 pounds per linear inch to 300 pounds per linear inch (5.4 kilograms to 54 kilograms per centimeter). By way of further example, the applied pressure may range from 30 pounds per linear inch to 100 pounds per linear inch (5.4 kilograms to 18 kilograms per linear centimeter). The stacked membrane 100 and the sheet 114 may experience the applied pressure for a controlled amount of dwell time. For example, the dwell time may be 0.001 second to 2 seconds, which may depend on the line speed. Once the protective sheet 114 is heat laminated to the membrane 100, the roof laminate 10 is formed into a roll 38 (shown in FIG. 7). The laminate 10 is adhesive free (e.g., FIG. 2).

In one embodiment, the line speed as is represented by arrows 104 and 120 may be in the range of 20 to 100 feet per minute (6 to 30 meters per minute). The rate at which each of the membrane 100 and sheet 114 are pulled from their respective rolls 102, 112 may be the same. By way of further example only, the line speed may be from about 30 feet per minute (about 9 meters per minute) to about 33 feet per minute (about 10 meters per minute) (i.e., within a few feet per minute, plus or minus 2 feet per minute (0.6 meter per minute)).

In an alternative embodiment, and with reference to FIG. 12, the roof laminate 10 is formed by heating a membrane 200, which may be supplied via a stock roll 202. As shown, the membrane 200 is pulled from the roll 202 according to arrow 204 around drum or roller 206. The roller 206 may be heated to a temperature of between 100° F. (37.8° C.) and 400° F. (204° C.) and so heat the membrane 200 while the membrane 200 is in contact with the roller 206. In one embodiment, the roller 206 is set to a temperature of about 300° F. (about 149° C.) (i.e., within a few degrees, plus or minus 3° F. (−16.1° C.)). The temperature of the membrane 200 may be dependent on the material of the membrane 200 as well as other process conditions described below. The roller 206 heats the membrane 200 prior to forming the roof laminate 10.

At the same time, a sheet 214 is pulled from a roll 212 and passes around roller 216 according to arrow 220. Similar to sheet 114 of FIG. 11, although not shown in FIG. 12, the sheet 214 may be a multilayer protective sheet 14 shown, for example, in FIGS. 2-4 or a single layer sheet. Multilayer sheets may be preassembled prior to being assembled with the membrane 200 as shown in FIG. 12. The roller 216 may be heated to a temperature of between 100° F. (37.8° C.) and 400° F. (204° C.) and so heats the sheet 214 during contact. In one embodiment, the roller 216 is set to a temperature of about 300° F. (about 149° C.) (i.e., within a few degrees, plus or minus 3° F. (−16.1° C.)). The roller 206 and the roller 216 may be heated to different temperatures. The temperature of the sheet 214 may be dependent on the material of the sheet 214 as well as other process conditions described below. The roller 216 heats the sheet 214 prior to forming the roof laminate 10.

Once heated, each of the sheet 214 and the membrane 200 contact one another at 222. That is, at 222 the sheet 214 is stacked against the membrane 200. No adhesive, tackifiers, or chemicals are applied to or between the sheet 214 and the membrane 200. The sheet 214 is not intentionally stretched prior to or during contact with the membrane 200 at 222. As an example, each of membrane 200 and the sheet 214 contact one another at 222 and pass through a nip roller 224 and so are pressed together to form the laminate 10. The nip roller 224 may apply pressure in a range from 30 pounds per linear inch to 300 pounds per linear inch (5.4 kilograms per linear centimeter to 54 kilograms per linear centimeter). By way of further example, the applied pressure may range from 30 pounds per linear inch to 100 pounds per linear inch (5.4 kilograms per linear centimeter to 18 kilograms per linear centimeter). The stacked membrane 200 and the sheet 214 may experience the applied pressure for a controlled amount of dwell time. For example, the dwell time may be 0.001 second to 2 seconds, which may depend on the line speed. Once the protective sheet 214 is heat laminated to the membrane 200, the roof laminate 10 is formed into a roll 38 (shown in FIG. 7). The laminate 10 is adhesive free (e.g., FIG. 2).

In one embodiment, the line speed as is represented by arrows 204 and 220 may be in the range of 20 to 100 feet per minute (6.1 to 30.5 meters per minute). The rate at which each of the membrane 200 and sheet 214 are pulled from their respective rolls 202, 212 may be the same. By way of further example only, the line speed may be from about 40 feet per minute (about 12.2 meters per minute) to about 45 feet per minute (about 13.7 meters per minute) (i.e., within a few feet per minute, plus or minus 2 feet per minute (0.61 meter per minute)).

Not being bound by theory, the protective sheet 14 may adhere to the membrane 12 via interdiffusion of polymer chains from the protective sheet 14 into the membrane 12, from the membrane 12 into the protective sheet 14, or from each of the protective sheet 14 and the membrane 12 into the other of the membrane 12 and the protective sheet 14. That is, heat combined with the pressure may cause a blurring of the interface between the protective sheet 14 and the membrane 12. The amount of interdiffusion adhesion may be dependent on the polymers of the protective sheet 14 and the membrane 12 as well as the temperature, pressure, and contact time under pressure at which the surfaces for each are brought into contact with one another to form an interface.

By way of example only and not limitation and with reference to FIGS. 13A, 13B, 13C, and 13D, amounts of interdiffusion adhesion are schematically illustrated at an interface 96 between a protective sheet 88 and a membrane 98 under different heat lamination conditions including at least one of a change in temperature of the protective sheet 88 and the membrane 98 and applied pressure. In general, the amount of interdiffusion adhesion increases from the condition shown in FIG. 13A to the interdiffusion adhesion shown in FIG. 13D. As the amount of interdiffusion adhesion increases, a peel value, which is a measure of force required to separate the protective sheet 88 from the membrane 98, also increases. A procedure for determining a peel value of separation forces between a protective sheet and a membrane is described below with reference to Example 2.

In FIG. 13A, no interdiffusion across the interface 96 is shown, and so the protective sheet 88 is only slightly adhered to the membrane 98. Thus, a peel value between the protective sheet 88 and the membrane 98 with this configuration may be minimal and may be sufficient to resist separation only during handling. In FIG. 13B, the interface 96 may be represented by contact at the molecular level though there may still be little interdiffusion between the protective sheet 88 and the membrane 98. Thus, a peel value between the protective sheet 88 and the membrane 98 may be greater than the configuration shown in FIG. 13A. By way of example only, a peel value may be at least 0.01 pounds per inch (0.002 kilograms per centimeter) and by way of additional example, in the range of 0.01 pounds per inch to 0.5 pounds per inch (0.002 kilograms to 0.009 kilogram per centimeter).

In FIG. 13C, which may represent the result of a heat lamination process, such as that described above, the interface 96 may include interdiffusion between the protective sheet 88 and the membrane 98 such that the interface 96 is no longer easily discerned. That is, molecules of the protective sheet 88 may extend across the interface 96 and into the membrane 98. Similarly, molecules of the membrane 98 may extend across the interface 96 and into the protective sheet 88. This configuration may provide a peel value in the range of 0.1 pounds per inch to 5 pounds per inch (0.02 kilograms per centimeter to 0.9 kilograms per centimeter). In FIG. 13D, the interface 96 may include interdiffusion between the protective sheet 88 and the membrane 98. Like the interface 96 in FIG. 13C, the interface 96 shown in FIG. 13D may not be discernible. However, the interdiffusion in FIG. 13D is greater than the interdiffusion illustrated shown in FIG. 13C. Thus, the penetration and intermingling of the polymers in the protective sheet 88 and the membrane 98 is increased such that the depth of penetration of the polymers across the interface 96 is increased. By way of example only, this configuration may provide a peel value in the range of 0.05 pounds per inch to 20 pounds per inch (0.009 kilogram per centimeter to 3.6 kilograms per centimeter).

As an alternative to a heat lamination process, for example those described above, the protective sheet 14 may be adhered to the membrane 12 via a process that produces physical adsorption, which may include Van der Waals interaction. This type of adhesion may be referred to as interfacial adhesion and may not result in interdiffusion. It is contemplated that if the surface properties of the protective sheet 14 and the membrane 12 are different, there may be an electrostatic attraction between the two surfaces. Electrostatic attraction may be due to ionic nature of the surfaces or formation of an electric double layer at the interface between the protective sheet 14 and the membrane 12, which results in mutual attraction. Processes that may produce or enhance electrostatic interaction between surfaces may include plasma treatment of surfaces, coronal discharge treatment of the surfaces, or flame surface treatment. These processes may produce an interface such as that shown in FIG. 13A or FIG. 13B.

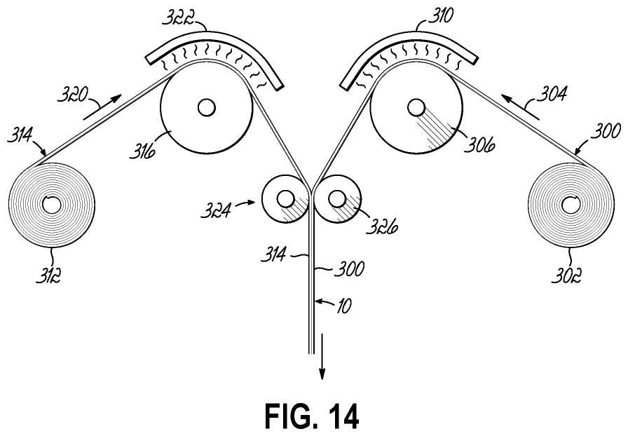

As an example, and with reference to FIG. 14, the roof laminate 10 is formed by surface treating a membrane 300, which may be supplied via a stock roll 302. As shown, the membrane 300 is pulled from the roll 302 according to arrow 304 around drum or roller 306. Treatment at 310 may include any single one of plasma treatment, coronal discharge, or flame treatment on a surface of the membrane 300. As examples, in atmospheric plasma treatment, the membrane 300 is exposed to a plasma formed by a plasma generator (not shown) (e.g., operated at 15 kHz and an intermediate voltage 300V) that is coupled to a plasma torch with a nozzle (rotating or static). The membrane 300 may be exposed to the plasma discharge from the nozzle at a distance of 2 mm (0.08 inch) to 20 mm (0.8 inch). In corona treatment, a high-voltage electrical discharge spans an air gap between an electrode and a dielectric. That discharge forms a corona and the surface of the membrane 300 is exposed to that corona. The power of the discharge can vary from 0.5 kW to 40 kW. In flame treatment, the surface of the membrane 300 is exposed to a burner unit. The burner unit may combust a natural gas-hair mixture (e.g. at a ratio of 9.6 to 1 to produce a sheet content of 38 Joules per cubic centimeter) with a flame of about 4 mm (about 0.2 inch) from a nozzle on the burner unit. An oxygen rich plasma treats the surface exposed to the flame. A distance between the nozzle and the surface of the membrane 300 may be 30 mm (1 inch) and exposure time may be varied from 0.02 second to 0.1 second.

At the same time, a sheet 314 is pulled from a roll 312 and passes around roller 316 according to arrow 320 and past a surface treatment process at 322. Although not shown in FIG. 14, the sheet 314 may be a multilayer protective sheet 14 shown, for example, in FIGS. 2-4 or a single layer sheet. Multilayer sheets may be preassembled prior to being assembled with the membrane 300 as shown in FIG. 14. Treatment at 322 may include any single one of plasma treatment, coronal discharge, or flame treatment or a combination of those on a surface of the sheet 314. The treatment at 322 may be the same treatment as the treatment at 310, though embodiments of the invention are not limited to the treatments being the same.

Once treated, each of the sheet 314 and the membrane 300 contact one another at 324. That is, at 324, the treated surface of the sheet 314 is brought into contact with the treated surface of the membrane 300. No adhesive, tackifiers, or chemicals are applied to or between the sheet 314 and the membrane 300. The sheet 314 is not intentionally stretched prior to or during contact with the membrane 300 at 324. As an example, each of membrane 300 and the sheet 314 contact one another at 324 and pass through a nip roller 326 and so are pressed together to form the laminate 10. The nip roller 326 may apply pressure in a range from 1 pounds per linear inch to 300 pounds per linear inch (0.2 kilograms per linear centimeter to 54 kilograms per linear centimeter). By way of further example, the applied pressure may range from 30 pounds per linear inch to 200 pounds per linear inch (5.4 kilograms per linear centimeter to 36 kilograms per linear centimeter). The stacked membrane 300 and the sheet 314 may experience the applied pressure for a controlled amount of dwell time. For example, the dwell time may be 0.001 second to 2 seconds, which may depend on the line speed. Once the protective sheet 314 is laminated to the membrane 300, the roof laminate 10 is formed into a roll 38 (shown in FIG. 7). The laminate 10 is adhesive free (e.g., FIG. 2).

In one embodiment, the line speed as is represented by arrows 304 and 320 may be in the range of 20 to 100 feet per minute (6.1 to 30.5 meters per minute). The rate at which each of the membrane 300 and sheet 314 are pulled from their respective rolls 302, 312 may be the same. By way of further example only, the line speed may be from about 40 feet per minute (about 12 meters per minute) to about 45 feet per minute (about 14 meters per minute) (i.e., within a few feet per minute, plus or minus 2 feet per minute (0.6 meter per minute)).

As a prophetic example, a 60 mil by 10 foot (1.5 millimeter by 3 meters) PVC or TPO roofing membrane can be surface treated with plasma, corona, or flame treatment. A flexible PVC film may be similarly treated and brought into contact with the surface treated PVC or TPO membrane under an applied pressure of 1 pound per linear inch to 100 pounds per linear inch (0.2 kilograms per linear centimeter to 18 kilograms per linear centimeter). It is believed that this process will produce a peel value of 0.1 to 0.3 pounds per inch (0.02 to 0.0.05 kilogram per centimeter).

### Examples 1 and 2

A roofing membrane of a 60 mil by 10 foot (1.5 millimeter by 3 meters) PVC sheet and a protective sheet of flexible PVC were heat laminated together with a process schematically shown in FIG. 11. The line speed was 30 feet per minute (9 meters/minute). The 60 mil (1.5 millimeter) PVC sheet had a temperature of 240° F. (116° C.) when exiting the heating zone. A nip pressure of 50 pounds per linear inch (8.9 kilograms per linear centimeter) was used to press the 60 mil (1.5 millimeter) PVC sheet and the PVC protective sheet together. The laminate had a peel value between the PVC protective sheet and the 60 mil (1.5 millimeter) PVC sheet of 1.0 pound per inch (0.18 kilogram per linear centimeter).

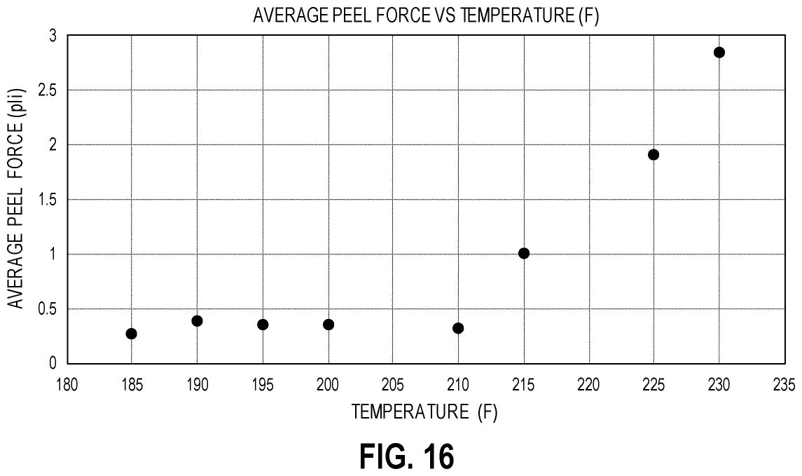

A roofing membrane of a 60 mil by 10 foot (1.5 millimeter by 3 meters) PVC sheet and a protective sheet of flexible PVC were heat laminated together with a process schematically shown in FIG. 11. The line speed was 33 feet per minute (10 meters per minute). The temperature for the 60 mil (1.5 millimeter) PVC sheet when exiting the heat zone 108 was changed in a periodic manner to map the peel value as a function of heat zone temperature. A nip pressure of 80 pounds per linear inch (14 kilograms per linear centimeter) was used to press the 60 mil PVC sheet and the PVC protective sheet together. The peel values of each laminate were measured and are tabulated in Table 1. Five samples of each laminate were manufactured. FIG. 16 represents data of Table 1 in graphical form. The adhesion force between the protective film and roof membrane is primarily influenced by temperature, pressure, and contact time at temperature and pressure.

FIG. 16 illustrates the temperature influence on adhesion in this example (i.e., fixed contact time and fixed pressure). It is contemplated that in a temperature range of 185° F. (85° C.) to 210° F. (98.9° C.), the molecular model would be close to that depicted in FIGS. 13B and 13C. In other words, there are some interaction and entanglement at the interface between polymer chains between the PVC sheet and PVC membrane. It is likewise contemplated that at temperatures over 210° F. (98.9° C.) there is an increase in entanglement between polymer chains of the sheet and the membrane. When polymer chain entanglement becomes significant, it is observed that it is increasingly difficult to distinguish the interface between the sheet and the membrane. This is believed to occur above 250° F. (121° C.) under the temperature and pressure conditions in the example. FIG. 13D is believed to represent the interface at this combination of temperature, pressure, and time. As such, temperatures in the range of 210° F. (98.9° C.) to 235° F. (113° C.) are believed to provide sufficient entanglement/adhesion value for handling and installation but also permit removal of the protective sheet from the membrane. In contrast, the entanglement represented in FIG. 13D may present a problem for removal of the sheet after installation because of the difficultly in removing the sheet from the membrane.

TABLE 1

| Lamination | Temperature | Average of five |
|---|---|---|
| Pressure | exiting heat zone | peel adhesion |
| (psi) | (° F.) | (pli) |
| 80 | 185 | 0.284 |
| 80 | 190 | 0.392 |
| 80 | 195 | 0.368 |
| 80 | 200 | 0.358 |
| 80 | 210 | 0.338 |
| 80 | 215 | 1.016 |
| 80 | 225 | 1.916 |
| 80 | 230 | 2.852 |

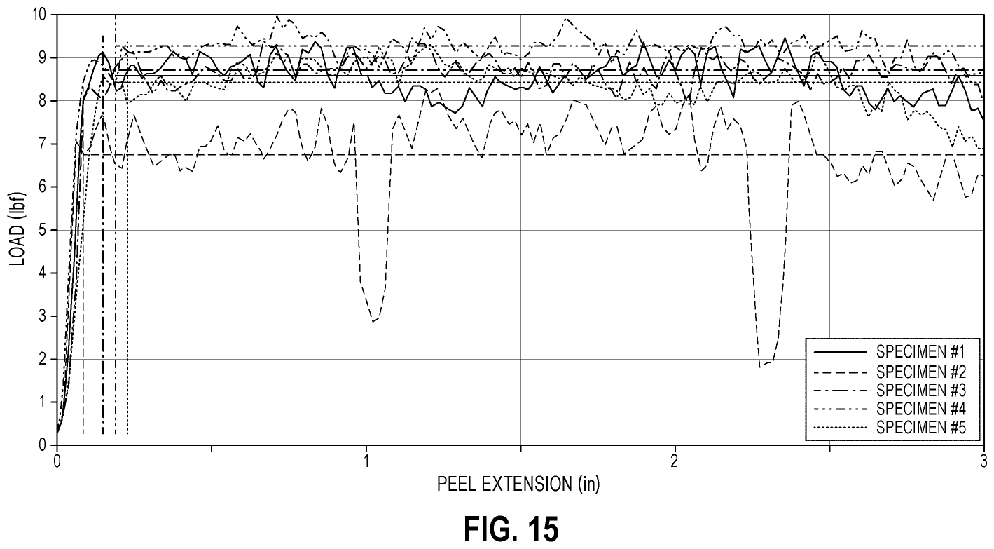

A data plot from testing of five different specimens assembled in accordance with Example 2 is shown in FIG. 15. As shown, there is variability in adhesion between the specimens 1-5. The peel value is determined as an average load for each specimen. The peel value above is an average peel value for the 5 specimens.

The procedure for measuring a peel value, as described herein, was as follows:
(1) A 3-inch (7.6 centimeters) wide by 6-inch (15 centimeters) long specimen was cut from the prepared laminate.
(2) Using a ruler, a line was drawn across the specimen 2 inches (5 centimeters) from one end along the 6-inch (15 centimeters) length.
(3) The protective sheet was manually peeled from the membrane to the line to produce a tab leaving 4 inches (10 centimeters) of protective sheet adhered to the membrane.
(4) The laminate was adhered to a 4-inch (10 centimeters) wide by 7-inch (18 centimeters) long at a support plate with tape opposite the tab.
(5) The specimen was mounted in a 3365 Instron testing machine with a 20-pound (9 kilograms) load cell and 3-inch (8 centimeters) wide pneumatic grips.
   (a) The specimen was vertically mounted in the opposing grips so that the protective sheet was pulled in a direction substantially parallel to the support plate and to the membrane.
   (b) The support plate was mounted in one set of pneumatic grips and the tab was coupled to the opposing pneumatic grips with a piece of masking tape attached to the tab.
(6) Following calibration of the load cell, the tab was pulled at a rate of 2 inches per minute (5 centimeters per minute). The peel value was calculated from the data shown in FIG. 15.

### Examples 3 and 4

A roofing membrane of a 60 mil by 3-foot (0.914 meter) PVC sheet and a protective sheet of rigid PVC sheet were heat laminated together with a process schematically shown in FIG. 12. The heat drums were set to 300° F. (149° C.) for both the 60 mil (1.5 millimeters) PVC sheet and the rigid PVC sheet. The line speed was 42 feet per minute (12.8 meters per minute). A nip pressure of 160 pounds per linear inch (29 kilograms per linear centimeter) was used to press the 60 mil (1.5 millimeters) PVC sheet and the PVC protective sheet together. The roofing membrane had a peel value between the PVC protective sheet and the rigid 60 mil (1.5 millimeters) PVC sheet of 3.0 pound per inch (0.54 kilograms per linear centimeter).

A roofing membrane of a 60 mil by 3-foot (1.5 millimeters by 0.9 meter) PVC sheet and a protective sheet of semi-rigid PVC sheet were heat laminated together with a process schematically shown in FIG. 12. The sheet drums were set to 300° F. (149° C.) for both the 60 mil (1.5 millimeters) PVC sheet and the semi-rigid PVC sheet. The line speed was 42 feet per minute (12.8 meters per minute). A nip pressure of 160 pounds per linear inch (29 kilograms per linear centimeter) was used to press the 60 mil PVC sheet (1.5 millimeters) and the semi-rigid PVC protective sheet together. The roofing membrane had a peel value between the semi-rigid PVC protective sheet and the 60 mil (1.5 millimeters) PVC sheet of 1.0 pound per inch (0.18 kilogram per linear centimeter).

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

1. A method of manufacturing a roof laminate comprising:
heating one or both of a membrane and a protective sheet; and
while hot, pressing the membrane and the protective sheet together in the absence of adhesive and in the absence of a tackifier between the membrane and the protective sheet.

2. The method of claim 1 wherein pressing the membrane and the protective sheet together includes applying a pressure in the range of 30 to 300 pounds per linear inch to the membrane and the protective sheet.

3. The method of claim 1 wherein pressing the membrane and the protective sheet together includes applying a pressure in the range of 30 to 100 pounds per linear inch to the membrane and the protective sheet.

4. The method of claim 1 wherein pressing the membrane and the protective sheet together includes applying a pressure to the membrane and the protective sheet for 0.001 second to 2 seconds.

5. The method of claim 1 wherein heating includes heating at least one of the membrane and the protective sheet to a temperature between 100° F. and 400° F.

6. A method of manufacturing a roof laminate comprising:
surface treating one or both of a membrane and a protective sheet; and
after treatment, pressing the membrane and the protective sheet together in the absence of adhesive and in the absence of a tackifier between the membrane and the protective sheet.

7. The method of claim 6 wherein pressing the membrane and the protective sheet together includes applying a pressure in the range of 1 to 200 pounds per linear inch to the membrane and the protective sheet.

8. The method of claim 6 wherein surface treating includes at least one of plasma treatment, coronal discharge, and flame treatment.

9. A roof laminate to be secured to a roof deck comprising:
a roof membrane that has a first surface and a second surface and is configured to be secured to the roof deck; and
a protective sheet that is removably affixed to the first surface in the absence of an adhesive and in the absence of a tackifier, the protective sheet being removable after the roof membrane is secured to the roof deck.

10. The roof laminate of claim 9 wherein the protective sheet is removably affixed to the roof membrane and is separable from the roof membrane when a force having a peel value of at least 0.01 pounds per inch is applied to the protective sheet.

11. The roof laminate of claim 9 wherein the protective sheet is removably affixed to the roof membrane and is separable from the roof membrane when a force having a peel value in the range of 0.05 pound per inch to 20 pounds per inch is applied to the protective sheet.

12. The roof laminate of claim 10 wherein the protective sheet includes at least a first layer directly secured to a second layer, one of the first layer and the second layer includes text or other indicia and the second layer is removably affixed to the roof membrane.

13. The roof laminate of claim 12 wherein one of the first layer and the second layer is colored.

14. The roof laminate of claim 12 wherein the first layer includes a pattern of raised areas spaced apart by recessed areas.

15. The roof laminate of claim 12 wherein the first layer has a static, dry coefficient of friction greater than 0.45 and a static wet coefficient of friction greater than 0.6.

16. The roof laminate of claim 12 wherein the first layer includes a coating that produces less than 30 gloss units at 60°.

17. The method of claim 2 wherein heating includes heating at least one of the membrane and the protective sheet to a temperature between 100° F. and 400° F.

18. The method of claim 3 wherein heating includes heating at least one of the membrane and the protective sheet to a temperature between 100° F. and 400° F.

19. The method of claim 4 wherein heating includes heating at least one of the membrane and the protective sheet to a temperature between 100° F. and 400° F.

20. The method of claim 7 wherein surface treating includes at least one of plasma treatment, coronal discharge, and flame treatment.
